(19) United States
(12) Patent Application Publication
(10) Pub. No.: US 2017/0226300 A1
(43) Pub. Date: Aug. 10, 2017

(54) EFFICIENT PRODUCTION OF COMPOSITE SEMIFINISHED PRODUCTS AND COMPONENTS IN A WET PRESSING METHOD USING HYDROXY FUNCTIONALIZED (METH)ACRYLATES WHICH ARE DUROPLASTICALLY CROSSLINKED USING ISOCYANATES OR URETDIONES

(71) Applicants: Sandra REEMERS, Muenster (DE); Zuhal TUNCAY, Herne (DE); Michael KUBE, Haltern am See (DE); Friedrich Georg SCHMIDT, Haltern am See (DE)

(72) Inventors: Sandra REEMERS, Muenster (DE); Zuhal TUNCAY, Herne (DE); Michael KUBE, Haltern am See (DE); Friedrich Georg SCHMIDT, Haltern am See (DE)

(73) Assignee: Evonik Degussa GmbH, Essen (DE)

(21) Appl. No.: 15/329,106

(22) PCT Filed: Jul. 23, 2015
(86) PCT No.: PCT/EP2015/066813

§ 371 Date: Jan. 25, 2017

(30) Foreign Application Priority Data
Jul. 28, 2014 (EP) 14178720.0

(51) Int. Cl. C08J 5/24; B32B 15/14; B32B 5/02; B29B 11/16

(52) U.S. Cl. CPC C08J 5/24; B29B 11/16; B32B 15/14; B32B 5/024; B29C 70/42

(57) ABSTRACT

The invention relates to a process for producing semi-finished composites and composite components. For production of the semi-finished products or components, (meth)acrylate monomers, (meth)acrylate polymers, polyfunctionalized (meth)acrylates, hydroxy-functionalized (meth)acrylate monomers and/or hydroxy-functionalized (meth)acrylate polymers are mixed with di- or polyisocyanates or with uretdione materials. This liquid mixture is applied by known processes to fibre material, for example carbon fibres, glass fibres or polymer fibres, and polymerized with the aid of a first temperature increase or of a redox accelerator or by means of photoinitiation. Polymerization, for example at room temperature or at up to 120° C., gives rise to thermoplastics which can still be subjected to a forming operation. The hydroxy-functionalized (meth)acrylate constituents can subsequently be crosslinked in a press with isocyanates or uretdiones already present in the system at a second temperature at least 20° C. above the polymerization temperature. In this case, the shaping to give the final component is effected simultaneously in this press. In this way, dimensionally stable thermosets or crosslinked composite components can be produced.

### FIELD OF THE INVENTION

The invention relates to a process for producing semi-finished composites and composite components. For production of the semi-finished products or components, (meth)acrylate monomers, (meth)acrylate polymers, polyfunctionalized (meth)acrylates, hydroxy-functionalized (meth)acrylate monomers and/or hydroxy-functionalized (meth)acrylate polymers are mixed with di- or polyisocyanates or with uretdione materials. This liquid mixture is applied by known processes to fibre material, for example carbon fibres, glass fibres or polymer fibres, and a polymerization is initiated with the aid of a first temperature increase or of a redox accelerator or by means of photoinitiation.

Polymerization, for example at room temperature or at up to 120° C., gives rise to thermoplastics or lightly crosslinked systems which can be formed in the course of polymerization or subsequently. The hydroxy-functionalized (meth)acrylate constituents can subsequently be crosslinked in a press with isocyanates or uretdiones already present in the system, with shaping for example, at a second temperature at least 20° C. above the polymerization temperature. In this case, the shaping to give the final component is effected simultaneously in this press. In this way, dimensionally stable thermosets or crosslinked composite components can be produced.

Fibre-reinforced materials in the form of composite materials are already being used in many industrial applications, for example by means of wet layup technology, because of their exceptional mechanical properties combined with simultaneously low weight in many fields of use. The industrial processing of such systems particularly requires short cycle times and high storage stability—even at room temperature. Short cycle times are important especially in relation to short occupation times of presses and/or other moulds, since the capital costs associated with this equipment are particularly high.

There are various processes for production of composite materials. The processes are unsuitable to date for mass production. An already relatively efficient operation for production of composite components is the wet pressing process. Here, fibres are pressed with matrix in a press to give a component in the final geometry. Fibres are often impregnated here directly in the press. This is disadvantageous since the occupation time of the press is increased thereby. The first attempts to conduct the impregnation outside the press to date have been laborious, since matrix material drips off the impregnated preform, and the preform is tacky and not dimensionally stable. The impregnated preform can therefore be inserted into the press in an automated manner only with difficulty, if at all. In some cases, the impregnated preforms are therefore frozen and transported into the press in frozen form. This is costly and inconvenient.

### STATE OF THE ART

As well as polyesters, vinyl esters and epoxy systems there are a number of specialized resins in the crosslinking matrix systems field. These also include polyurethane resins which, because of their toughness, damage tolerance and strength, are used particularly for production of composite profiles via pultrusion processes. A disadvantage often mentioned is that the isocyanates used are toxic. However the toxicity of epoxy systems and the curing components used there should also be regarded as critical. This applies especially for known sensitizations and allergies.

Information about the wet pressing process based on epoxy resins can be found in WO 2014/078219 and WO 2014/078218. Here, the impregnation of the fibre materials with the resin and the curing of the resin are effected with simultaneous shaping in the same mould. Such a procedure has the very great disadvantage of a very long mould occupation time. A further disadvantage is that a high level of offcuts of matrix-crosslinked fibre material is obtained and has to be discarded or disposed of.

Prepregs and composites produced therefrom that are based on epoxy systems are described, for example, in WO 98/50211, EP 309 221, EP 297 674, WO 89/04335 and U.S. Pat. No. 4,377,657. WO 2006/043019 describes a method for production of prepregs based on epoxy resin-polyurethane powders. Additionally known are prepregs based on pulverulent thermoplastics as matrix.

WO 99/64216 describes prepregs and composites and a method for production thereof, in which emulsions having polymer particles so small as to enable single fibre coating are used. The polymers of the particles have a viscosity of at least 5000 centipoise and are either thermoplastics or crosslinking polyurethane polymers.

EP 0590702 describes powder impregnations for production of prepregs, in which the powder consists of a mixture of a thermoplastic and a reactive monomer or prepolymer. WO 2005/091715 also describes the use of thermoplastics for production of prepregs.

Prepregs having a matrix based on two-component polyurethanes (2-K PUR) are likewise known. The 2-K PUR category essentially comprises the conventional reactive polyurethane resin systems. In principle, this is a system consisting of two separate components. While the critical constituent of one component is always a polyisocyanate, for example polymeric methylenediphenyl diisocyanates (MDI), the critical constituent in the second component comprises polyols or in more recent developments also amino- or amine-polyol mixtures. The two parts are mixed together only shortly before processing. Thereafter, the chemical curing takes place through polyaddition with formation of a network of polyurethane or polyurea. After the mixing of the two constituents, two-component systems have a limited processing period (service life, pot life), since the onset of reaction leads to a gradual increase in viscosity and finally to gelation of the system. Many variables determine its effective processibility period: reactivity of the co-reactants, catalysis, concentration, solubility, moisture content, NCO/OH ratio and ambient temperature are the most important [see: Lackharze (Coating Resins), Stoye/Freitag, Hauser-Verlag 1996, pages 210/212]. The disadvantage of the prepregs based on such 2-K PUR systems is that only a short period is available for processing of the prepreg to a composite. Therefore, such prepregs are not storage-stable over a number of hours, let alone days.

Apart from the different binder basis, moisture-curing coating materials correspond to largely analogous 2K systems both in terms of composition and in terms of properties. In principle, the same solvents, pigments, fillers and auxiliaries are used. Unlike 2K coatings, for stability reasons, these systems do not tolerate any moisture at all before their application.

DE 102009001793.3 and DE 102009001806.9 describe a method for production of storage-stable prepregs, essentially composed of A) at least one fibrous carrier and B) at least one reactive pulverulent polyurethane composition as matrix material.

These systems may also contain poly(meth)acrylates as co-binder or polyol components. In DE 102010029355.5 compositions of this type are introduced into the fibre material by a direct melt impregnation process. In DE 102010030234.1, by a pretreatment with solvents. Disadvantages of these systems are the high melt viscosity or the use of solvents, which have to be removed in the intervening period, or else can entail disadvantages from a toxicological point of view.

### Problem

The problem addressed by the present invention, against the background of the prior art, was that of providing a novel methodology for production of semi-finished composites or composite components, which enables short cycle times and/or shorter press and/or mould occupation times in the course of production compared to the prior art.

More particularly, intermediates of the process were to be storage-stable over several days or weeks before the final curing.

In addition, simple transport of the intermediates, also referred to as preforms hereinafter, should be possible without sticking or loss of shape, for example with a robot arm.

A further problem addressed by the present invention was that of producing less offcut material in the production of composites, and of making the offcut material obtained amenable to further use.

A particular problem addressed by the present invention was that of providing an accelerated process for producing semi-finished composites or composite components which enables impregnation of the fibre material outside the moulding press without having to take special precautions, for example significant cooling, on transfer into the press or a mould.

Further problems not stated explicitly may become apparent from the description, the examples and the claims.

### Solution

The objects are achieved by means of a novel process for producing semi-finished composites and further processing thereof to give mouldings. This novel process has the following process steps:

I. producing a liquid reactive composition,

II. directly impregnating a fibrous carrier with the composition from I.,

III. polymerizing monomer constituents in the liquid composition at a temperature T₁, and an optional preliminary shaping operation,

IV. finally shaping to give the later moulding in a press and/or another mould and

V. simultaneously curing the isocyanate component in the composition in this press at a temperature T₂ at least 20° C. higher than the temperature T₁ in process step III.

Between process steps III. and IV., intermediate storage of the semi-finished product is optionally also possible over a prolonged period. In addition, the semi-finished product, between these two process steps, can be heat-treated at a temperature between, for example, 30 and 100° C., preferably between 40 and 70° C.

The liquid reactive composition consists essentially of the following components:

A) a (meth)acrylate-based reactive resin component containing at least one (meth)acrylate monomer and at least one poly(meth)acrylate, where at least one constituent of the resin component has hydroxyl groups.

B) At least one blocked di- or polyisocyanate and/or at least one uretdione as isocyanate component.

The formulation described can be used, in process step III., to produce dry, storage-stable and optionally dimensionally stable impregnated prepregs or preforms—referred to hereinafter as intermediate product—outside the press.

The liquid mixture used in process step III., gives good impregnation of the carrier material outside the press, for example in an undermould, and not in the actual pressing mould which is used in process steps IV. and V. In this case, this undermould may simultaneously be one of several undermoulds of the pressing mould, each of which are run into the press together with the intermediate product. Alternatively, it is also possible to use a diaphragm forming technique here.

Polymerization of the mixture is then induced by thermal or non-thermal means outside the press. The result is a thermoplastic semi-finished product which is dry and non-tacky. This thermoplastic semi-finished product, on removal from the undermould, exhibits a good dimensional stability, and can be removed from the undermould in an automated manner and inserted into the hot press. It is also possible to lay several plies of these thermoplastic semi-finished products into the press. In addition, it is also possible to lay other layers, for example of metal, wood, plastics or another material, into the press as well. For example, it is possible to provide cable ducts or screw connection sites in the later moulding by means of inserts. At this point in the process, it is also possible to trim the semi-finished product or cut it to size.

In the press at operating temperature, the hydroxy-functionalized (poly)(meth)acrylates are crosslinked with the isocyanates which are formed at temperature T₂ from the uretdiones and/or blocked isocyanates already present in the system, so as to form a dimensionally stable thermoset component.

More preferably, the ratio of the resin component A) to the isocyanate component B) is between 90:10 and 40:60. Most preferably, the resin component and the isocyanate component are present in such a ratio to one another that there is 0.3 to 1.0, preferably 0.4 to 0.8, more preferably 0.45 to 0.65, uretdione group—corresponding to 0.6 to 2.0, preferably 0.8 to 1.8 and more preferably 0.9 to 1.3 externally blocked isocyanate groups in the isocyanate component—for each hydroxyl group in the resin component A).

It should be pointed out here that the resin component, as well as the (meth)acrylate monomers and poly(meth)acrylates present in accordance with the invention, may also contain further constituents which contribute to the OH number. These especially include the polyols described below that are optionally present.

The resin component A) is at least composed of 30% by weight to 100% by weight of monomers and 0% by weight to 70% by weight of prepolymers. The expression “monomers” encompasses (meth)acrylates and monomers copolymerizable with (meth)acrylates, which, in this assessment, are not crosslinkers, i.e., for example, di-, tri- or oligo(meth)acrylates, or urethane (meth)acrylates.

The resin component is especially at least composed of 0% to 10% by weight, preferably 0% to 3% by weight, of crosslinker, which is preferably a di-, tri- or oligo(meth)acrylate here, 20% to 100% by weight, preferably 30% to 90% by weight, more preferably 35% to 80% by weight and especially preferably 40% to 60% by weight of monomers, 0% to 20% by weight, preferably 1% to 10% by weight, of urethane (meth)acrylates, 0% to 70% by weight, preferably 5% to 40% by weight and more preferably 10% to 30% by weight of one or more prepolymers, and 0% to 10% by weight, preferably 0.5% to 8% by weight and more preferably 1.5% to 5% by weight of one or more initiators. In a particular embodiment, the resin may further contain 0% to 50% by weight, preferably 5% by weight to 30% by weight and more preferably up to 25% by weight of one or more polyols. The exact selection of these polyols is described further down.

The advantage of this system according to the invention lies in the production of a formable thermoplastic semi-finished product/prepregs which is crosslinked to give a thermoset material in a further step in the production of the composite components. The starting formulation is liquid and hence suitable for the impregnation of fibre material without addition of solvents. The semi-finished products are storage-stable at room temperature. The resultant mouldings have elevated heat distortion resistance compared to other polyurethane systems. Compared to standard epoxy systems, they are notable for higher flexibility. In addition, such matrices can be laid out in light-stable form and hence can be used for the production of carbon fibre-wrapped parts without further painting.

In addition, the mouldings produced in accordance with the invention have the great advantage over the prior art that they can be produced with less offcut material, or the offcut material obtained can be reused and for the most part need not be disposed of. In the current one-stage prior art operations, the component is cut to size or deburred after the component has been produced. The material removed, consisting of the crosslinked matrix and the fibres used, cannot profitably be used further in these cases and is sent, for example, to thermal disposal. In the present case, the thermoplastic semi-finished product can be cut to size. The offcut material can be reused in further processes such as SMC, in which short chopped fibres are used.

A further advantage of the present invention is that the process can be conducted without the use of clamping frames. As a result, a distinctly lower level of excess material which is removed later as offcuts is obtained in this process.

It has been found that, surprisingly, adequately impregnated, reactive and storage-stable semi-finished composites can be produced by producing them with the abovementioned combination of a (meth)acrylate reactive resin and an isocyanate component.

This affords semi-finished composites having at least the same or even improved processing properties compared to the prior art, which are usable for the production of high-performance composites for a wide variety of different applications in the construction, automotive and aerospace sectors, in the energy industry (wind turbines) and in boat- and shipbuilding. The reactive compositions usable in accordance with the invention are environmentally friendly and inexpensive, have good mechanical properties, are easy to process and feature good weathering resistance after curing and a balanced ratio of hardness to flexibility.

Further advantages of the present invention are that, for example, favourable undermoulds or diaphragms can be used in the shaping, rather than press moulds producible only at great cost. Furthermore, particularly good impregnation of the carrier material is possible through use of a low-viscosity composition.

In addition, a partial reaction proceeds in the form of the polymerization outside the press. Thus, automations of the process are much easier to implement.

Moreover, the intermediate product from process step III. is non-tacky and dry and has exceptional dimensional and storage stability. Thus, automated transfer of this intermediate product into the press can be conducted in a simple manner. In this way, and by virtue of the other advantages of the present invention, the cycle time in the press in particular is distinctly shortened. This is especially possible because both the impregnation and parts of the reaction take place outside the press.

In addition, the intermediate from process step III can be stacked, sawn, processed further and also preformed prior to process step IV.

In addition, in this process step, offcut material from the inventive moulding production can be incorporated. However, such a course of action is less preferred compared to the use of the offcut material in other SMC processes with short-fibre material.

Particularly surprising, it has been found in this context that the process according to the invention enables distinctly accelerated production of these semi-finished composites compared to the prior art. The shaping in process step IV. can be effected on an already solid intermediate product which is easy to transport. Only when the shaping is complete is the final curing to give the final semi-finished composite then effected in process step V. This process thus brings the additional advantage that it has very good continuous automatability. Thus, it is especially possible to undertake the first curing in process step III. on the one hand and the shaping and final curing in process steps IV. and V. on the other hand in separate apparatuses. It is thus additionally possible to distinctly shorten the cycle times compared to the prior art, with only one curing step. In addition, the process can thus be implemented in a continuously operated production line.

In the context of this invention, the term “semi-finished composite” is used synonymously with the terms “prepreg”, “preform” or “organic sheet”. A prepreg is generally a precursor of thermoset composite components. An organic sheet is normally a corresponding precursor of thermoplastic composite components.

### The Carrier Material

The fibrous carrier in the present invention consists of fibrous material (also often called reinforcing fibres). Any material that the fibres consist of is generally suitable, but preference is given to using fibrous material made of glass, carbon, plastics such as polyamide (aramid) or polyester, natural fibres, or mineral fibre materials such as basalt fibres or ceramic fibres (oxidic fibres based on aluminium oxides and/or silicon oxides). It is also possible to use mixtures of fibre types, for example woven fabric combinations of aramid and glass fibres, or carbon and glass fibres. It is likewise possible to produce hybrid composite components with prepregs made from different fibrous carriers.

Mainly because of their relatively low cost, glass fibres are the most commonly used fibre types. In principle, all kinds of glass-based reinforcing fibres are suitable here (E glass, S glass, R glass, M glass, C glass, ECR glass, D glass, AR glass, or hollow glass fibres). In general, carbon fibres are used in high performance composite materials, where the lower density in comparison to glass fibres with at the same time high strength is also an important factor. Carbon fibres are industrially produced fibres composed of carbonaceous starting materials which are converted by pyrolysis to carbon in a graphite-like arrangement. A distinction is made between isotropic and anisotropic types: isotropic fibres have only low strengths and lower industrial significance; anisotropic fibres exhibit high strengths and rigidities with simultaneously low elongation at break. Natural fibres refer here to all textile fibres and fibrous materials which are obtained from plant and animal material (for example wood fibres, cellulose fibres, cotton fibres, hemp fibres, jute fibres, flax fibres, sisal fibres and bamboo fibres). Similarly to carbon fibres, aramid fibres exhibit a negative coefficient of thermal expansion, i.e. become shorter on heating. Their specific strength and their modulus of elasticity are markedly lower than those of carbon fibres. In combination with the positive coefficient of expansion of the matrix resin, it is possible to produce components of high dimensional stability. Compared to carbon fibre-reinforced plastics, the compressive strength of aramid fibre composite materials is much lower. Known brand names of aramid fibres are Nomex® and Kevlar® from DuPont, or Teijinconex®, Twaron® and Technora® from Teijin. Particularly suitable and preferred carriers are those made of glass fibres, carbon fibres, aramid fibres or ceramic fibres. The fibrous material is a sheetlike textile structure. Suitable materials are sheetlike textile structures made from nonwoven fabric, and likewise knitted fabric including loop-formed and loop-drawn knits, but also non-knitted fabrics such as woven fabrics, laid scrims or braids. In addition, a distinction is made between long-fibre and short-fibre materials as carriers. Likewise suitable in accordance with the invention are rovings and yarns. In the context of the invention, all the materials mentioned are suitable as fibrous carriers. There is an overview of reinforcing fibres in “Composites Technologies”, Paolo Ermanni (Version 4), Script for lecture at ETH Zurich, August 2007, Chapter 7.

The carrier material is generally preformed prior to process step II by laying it into the undermould, the press or the mould.

### Isocyanate Component

Isocyanate components used, as the first embodiment, are di- and polyisocyanates blocked with blocking agents or, as the second embodiment, internally blocked di- and polyisocyanates. The internally blocked isocyanates are what are called uretdiones.

The di- and polyisocyanates used in accordance with the invention may consist of any desired aromatic, aliphatic, cycloaliphatic and/or (cyclo)aliphatic di- and/or polyisocyanates. A list of possible di- and polyisocyanates and reagents for external blocking thereof can be found in German patent application DE 102010030234.1.

The external blocking agent for the di- or polyisocyanates is preferably ethyl acetoacetate, diisopropylamine, methyl ethyl ketoxime, diethyl malonate, ε-caprolactam, 1,2,4-triazole, phenol or substituted phenols and/or 3,5-dimethylpyrazole.

The polyisocyanates used in accordance with the invention, in a first embodiment, are externally blocked. External blocking agents are useful for this purpose, as found, for example, in DE 102010030234.1. The di- or polyisocyanates used in this embodiment are preferably hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI) and/or norbornane diisocyanate (NBDI), and it is also possible to use the isocyanurates. Preferred blocking agents are selected from ethyl acetoacetate, diisopropylamine, methyl ethyl ketoxime, diethyl malonate, E-caprolactam, 1,2,4-triazole, phenol or substituted phenols and/or 3,5-dimethylpyrazole. The curing components used are more preferably isophorone diisocyanate (IPDI) adducts containing isocyanurate moieties and ε-caprolactam-blocked isocyanate structures.

In addition, the isocyanate component may contain 0.01% to 5.0%, preferably 0.1% to 5.0%, by weight of catalysts. Catalysts used are preferably organometallic compounds such as dibutyltin dilaurate, zinc octoate or bismuth neodecanoate, and/or tertiary amines, more preferably 1,4-diazabicyclo[2.2.2]octane. Tertiary amines are especially used in concentrations between 0.001% and 1% by weight. These reactive polyurethane compositions used in accordance with the invention can be cured, for example, under standard conditions, for example with DBTL catalysis, at or above 160° C., typically at or above about 180° C.

In a second, preferred embodiment, the isocyanate components have been internally blocked. The internal blocking is effected via dimer formation via uretdione structures which, at elevated temperature, are dissociated back to the isocyanate structures originally present and hence set in motion the crosslinking with the binder.

Polyisocyanates containing uretdione groups are well-known and are described, for example, in U.S. Pat. No. 4,476,054, U.S. Pat. No. 4,912,210, U.S. Pat. No. 4,929,724 and EP 417 603. A comprehensive overview of industrially relevant methods for dimerization of isocyanates to uretdiones is given by J. Prakt. Chem. 336 (1994) 185-200. In general, isocyanates are converted to uretdiones in the presence of soluble dimerization catalysts, for example dialkylaminopyridines, trialkylphosphines, phosphoramides or imidazoles. The reaction, optionally carried out in solvents, but preferably in the absence of solvents, is stopped—by addition of catalyst poisons—once a desired degree of conversion is attained. Excess isocyanate monomer is subsequently separated off by short-path evaporation. If the catalyst is sufficiently volatile, the reaction mixture may be freed of the catalyst in the course of monomer removal. It is possible to dispense with the addition of catalyst poisons in this case. In principle, there is a wide range of isocyanates suitable for preparing polyisocyanates containing uretdione groups. It is possible to use the abovementioned di- and polyisocyanates.

Both for the embodiment of the externally blocked isocyanates and for the embodiment of the uretdiones, preference is given to di- and polyisocyanates formed from any desired aliphatic, cycloaliphatic and/or (cyclo)aliphatic di- and/or polyisocyanates. The invention uses isophorone diisocyanate (IPDI), hexamethylene diisocyanate (HDI), diisocyanatodicyclohexylmethane (H₁₂MDI), 2-methylpentane diisocyanate (MPDI), 2,2,4 trimethylhexamethylene diisocyanate/2,4,4-trimethylhexamethylene diisocyanate (TMDI), norbornane diisocyanate (NBDI). Very particular preference is given to using IPDI, HDI, TMDI and H₁₂MDI, and it is also possible to use isocyanurates.

Very particular preference is given to using IPDI and HDI for the matrix material. The conversion of these polyisocyanates containing uretdione groups to curing agents a) containing uretdione groups includes the reaction of the free NCO groups with hydroxyl-containing monomers or polymers.

Preferred curing agents a) having uretdione groups have a free NCO content of less than 5% by weight and a content of uretdione groups of 3% to 60% by weight, preferably 10% to 40% by weight (calculated as C₂N₂O₂, molecular weight 84). Preference is given to polyesters and monomeric dialcohols. Apart from the uretdione groups, the curing agents may also have isocyanurate, biuret, allophanate, urethane and/or urea structures.

The isocyanate component is preferably in solid form below 40° C. and in liquid form above 125° C. Optionally, the isocyanate component may contain further auxiliaries and additives known from polyurethane chemistry. In relation to the uretdione-containing embodiment, the isocyanate component has a free NCO content of less than 5% by weight and a uretdione content of 3% to 60% by weight.

In addition, the isocyanate composition of this embodiment may contain 0.01% to 5% by weight, preferably 0.3% to 2% by weight, of at least one catalyst selected from quaternary ammonium salts, preferably tetraalkylammonium salts, and/or quaternary phosphonium salts with halogens, hydroxides, alkoxides or organic or inorganic acid anions as counterion, and optionally 0.1% to 5% by weight, preferably 0.3% to 2% by weight, of at least one cocatalyst selected from at least one epoxide and/or at least one metal acetylacetonate and/or quaternary ammonium acetylacetonate and/or quaternary phosphonium acetylacetonate. All amounts stated for the (co-)catalysts are based on the overall formulation of the matrix material.

Examples of metal acetylacetonates are zinc acetylacetonate, lithium acetylacetonate and tin acetylacetonate, alone or in mixtures. Preference is given to using zinc acetylacetonate. Examples of quaternary ammonium acetylacetonates or quaternary phosphonium acetylacetonates can be found in DE 102010030234.1. Particular preference is given to using tetraethylammonium acetylacetonate and tetrabutylammonium acetylacetonate. It is of course also possible to use mixtures of such catalysts.

Examples of the catalysts can be found in DE 102010030234.1. These catalysts may be added alone or in mixtures. Preference is given to using tetraethylammonium benzoate and tetrabutylammonium hydroxide.

Useful epoxy-containing cocatalysts include, for example, glycidyl ethers and glycidyl esters, aliphatic epoxides, diglycidyl ethers based on bisphenol A, and glycidyl methacrylates. Examples of such epoxides are triglycidyl isocyanurate (TGIC, trade name: ARALDIT 810, Huntsman), mixtures of diglycidyl terephthalate and triglycidyl trimellitate (trade name: ARALDIT PT 910 and 912, Huntsman), glycidyl esters of Versatic acid (trade name: KARDURA E10, Shell), 3,4-epoxycyclohexylmethyl 3′,4′-epoxycyclohexanecarboxylate (ECC), diglycidyl ethers based on bisphenol A (trade name: EPIKOTE 828, Shell), ethylhexyl glycidyl ether, butyl glycidyl ether, pentaerythrityl tetraglycidyl ether (trade name: POLYPDX R 16, UPPC AG), and other Polypox products having free epoxy groups. It is also possible to use mixtures. Preference is given to using ARALDIT PT 910 and 912.

According to the composition of the reactive or highly reactive isocyanate component used and of any catalysts added, it is possible to vary the rate of the crosslinking reaction in the production of the composite components and the properties of the matrix within wide ranges.

### Resin Components

According to the invention, resin components used are methacrylate-based reactive resins. The notation “(meth)acrylates” encompasses both methacrylates and/or acrylates, and mixtures of methacrylates with acrylates. It is possible for both the monomers and the prepolymers, based on the respective component, to contain up to 25% by weight of a monomer copolymerizable or copolymerized with (meth)acrylates. Examples of such a monomer are especially styrene or 1-alkenes.

In addition, still further components may optionally be present. Auxiliaries and additives used in addition may be chain transfer agents, plasticizers, stabilizers and/or inhibitors. In addition, it is possible to add dyes, fillers, wetting, dispersing, separating and levelling aids, adhesion promoters, UV stabilizers, defoamers and rheology additives.

It is crucial for the present invention that at least some of the monomers and/or prepolymers from the resin component have hydroxyl groups as functional groups. Such hydroxyl groups react with the free isocyanate groups or uretdione groups from the isocyanate component in an addition reaction. With this reaction, the semi-finished composite in process step V. is finally cured. The resin component has an OH number of 10 to 600, preferably of 20 to 400 mg, more preferably of 40 to 200 mg KOH/gram. The broader limits are based especially, but without restriction, on the embodiment elucidated in detail further down, in which the resin component, in addition to the monomers and the optional prepolymers, contains further polyols. In the embodiment in which a pure (meth)acrylate resin is used without polyols, the OH number is preferably between 10 and 200 mg KOH/g.

More particularly, the amount of functional groups is chosen such that there are 0.6 to 2.0 isocyanate equivalents, or 0.3 to 1.0, preferably 0.4 to 0.8 and more preferably 0.45 to 0.65 uretdione group in the isocyanate component, for every hydroxyl group in the resin components. This corresponds to 0.6 to 2.0, preferably 0.8 to 1.6 and more preferably 0.9 to 1.3 externally blocked isocyanate groups in the isocyanate component.

The monomers present in the reactive resin are preferably compounds selected from the group of the (meth)acrylates, for example alkyl (meth)acrylates which have been obtained by esterification with straight-chain, branched or cycloaliphatic alcohols having 1 to 40 carbon atoms, e.g. methyl (meth)acrylate, ethyl (meth)acrylate, n-butyl (meth)acrylate or 2-ethylhexyl (meth)acrylate.

Suitable constituents of monomer mixtures also include additional monomers having a further functional group, such as α,β-unsaturated mono- or dicarboxylic acids, for example acrylic acid, methacrylic acid or itaconic acid; esters of acrylic acid or methacrylic acid with dihydric alcohols, for example hydroxyethyl (meth)acrylate or hydroxypropyl (meth)acrylate; acrylamide or methacrylamide; or dimethylaminoethyl (meth)acrylate. Further suitable constituents of monomer mixtures are, for example, glycidyl (meth)acrylate or silyl-functional (meth)acrylates.

An optional constituent of the inventive reactive resin is the crosslinkers. These are especially polyfunctional methacrylates such as allyl (meth)acrylate. Particular preference is given to di- or tri-(meth)acrylates, for example 1,4-butanediol di(meth)acrylate, tetraethylene glycol di(meth)acrylate, triethylene glycol di(meth)acrylate or trimethylolpropane tri(meth)acrylate. Minor crosslinking in process step III. barely disrupts the shaping in process step IV., if at all. In fact, these crosslinkers, present in small amounts, contribute to additional stabilization of the intermediate from process step III. However, the crosslinker content may account for a maximum of 10% by weight, preferably a maximum of 5% by weight, of component A).

Specifically, the composition of the monomers in terms of content and composition is appropriately chosen with regard to the desired technical function and the carrier material to be wetted.

The resin component, as well as the monomers listed, also contains polymers, referred to as prepolymers in the context of this property right for better distinction. In this case, at least 80% by weight of the polymer content is poly(meth)acrylates. In addition, further prepolymers, especially polyesters or polyethers, may be present at up to 20% by weight. Preferably, however, the prepolymers consist exclusively of poly(meth)acrylates.

These prepolymers are used to improve the polymerization properties, the mechanical properties, the adhesion to the carrier material, the setting of the viscosity in the course of processing in process steps II. and III., and the optical demands on the resins. The poly(meth)acrylates may have the hydroxyl functionalities exclusively or in addition to the monomers. However, it is also possible that the prepolymers do not have any functional groups or at least have no hydroxyl groups, and that the functional groups are possessed exclusively by the monomers of component A). Moreover, the prepolymers may have additional functional groups to promote adhesion.

The monomers involved in the composition of the said poly(meth)acrylates are generally the same as those already listed in relation to the monomers in the resin system. They may be obtained by solution, emulsion, suspension, bulk or precipitation polymerization and are added to the system as a pure substance.

Chain transfer agents used in the polymerization to give the prepolymer, and also as an additional constituent in component A), may be all the compounds known from free-radical polymerization. Preference is given to using mercaptans such as n-dodecyl mercaptan.

It is likewise possible to use conventional UV stabilizers. The UV stabilizers are preferably selected from the group of the benzophenone derivatives, benzotriazole derivatives, thioxanthonate derivatives, piperidinolcarboxylic ester derivatives or cinnamic ester derivatives. From the group of stabilizers or inhibitors, preference is given to using substituted phenols, hydroquinone derivatives, phosphines and phosphites.

Rheology additives used are preferably polyhydroxycarboxamides, urea derivatives, salts of unsaturated carboxylic acid esters, alkylammonium salts of acidic phosphoric acid derivatives, ketoximes, amine salts of p-toluenesulphonic acid, amine salts of sulphonic acid derivatives and aqueous or organic solutions or mixtures of the compounds. It has been found that rheology additives based on fumed or precipitated, optionally also silanized, silicas having a BET surface area of 10-700 nm²/g are particularly suitable.

Defoamers are preferably selected from the group of alcohols, hydrocarbons, paraffin-based mineral oils, glycol derivatives, derivatives of glycolic esters, acetic esters and polysiloxanes.

### Optional OH-Functional Co-Binders

Optionally, the resin composition, in addition to the methacrylate-based reactive resins, may contain polyols as OH-functional co-binders which likewise enter into a crosslinking reaction with the isocyanate components. By addition of these polyols which are unreactive in process step III, it is possible to more accurately adjust the rheology and hence the processing of semi-finished products from process step III, and of the end products. For example, the polyols act as plasticizers, or more specifically as reactive diluents, in the semi-finished product from process step III. The polyols can be added in such a way that up to 80%, preferably up to 50%, of the OH functionalities of the reactive resin are replaced thereby. In relation to the amount, the polyols may account for up to 50% by weight, preferably not more than 30% by weight and more preferably not more than 25% by weight of the resin composition.

Suitable OH-functional co-binders are in principle all polyols used customarily in PU chemistry, provided that the OH functionality thereof is at least two, preferably between three and six, with use of diols (difunctional polyols) only in mixtures with polyols having more than two OH functionalities. Functionality in the context of polyol compounds refers to the number of reactive OH groups they have in the molecule. For the end use, it is necessary to use polyol compounds having an OH functionality of at least 3 in order to form a three-dimensional dense network of polymer in the reaction with the isocyanate groups of the uretdiones. It is of course also possible to use mixtures of various polyols.

An example of a simple suitable polyol is glycerol. Other low molecular weight polyols are sold, for example, by Perstorp® under the Polyol®, Polyol® R or Capa® product names, by Dow Chemicals under the Voranol® RA, Voranol® RN, Voranol® RH or Voranol® CP product names, by BASF under the Lupranol® name and by DuPont under the Terathane® name. Details of specific products with specification of the hydroxyl numbers and the molar masses can be found, for example, in the German patent application having the priority reference 102014208415.6.

As an alternative to the low molecular weight polyols mentioned, it is also possible to use oligomeric polyols. These are, for example, linear or branched hydroxyl-containing polyesters, polycarbonates, polycaprolactones, polyethers, polythioethers, polyesteramides, polyurethanes or polyacetals, each of which are known per se, preferably polyesters or polyethers. These oligomers preferably have a number-average molecular weight of 134 to 4000. Particular preference is given to linear hydroxyl-containing polyesters—polyester polyols—or mixtures of such polyesters. They are prepared, for example, by reaction of diols with substoichiometric amounts of dicarboxylic acids, corresponding dicarboxylic anhydrides, corresponding dicarboxylic esters of lower alcohols, lactones or hydroxycarboxylic acids. Examples of suitable monomer units for such polyesters can likewise be found in German patent application having priority reference 102014208415.6.

Oligomeric polyols used are more preferably polyesters having an OH number between 25 and 800, preferably between 40 and 400, an acid number of not more than 2 mg KOH/g and a molar mass between 200 and 4000 g/mol, preferably between 300 and 800 g/mol. The OH number is determined analogously to DIN 53 240-2, and the acid number analogously to DIN EN ISO 2114. The molar mass is calculated from hydroxyl and carboxyl end groups.

With equal preference, polyethers are used as oligomeric polyols. These especially have an OH number between 25 and 1200, preferably between 250 and 1000, and a molar mass M_{w} between 100 and 2000 g/mol, preferably between 150 and 800 g/mol. An example of a particularly suitable polyether is Lupranol® 3504/1 from BASF Polyurethanes GmbH. The molar mass Mₙ is measured here by means of gel permeation chromatography against a PMMA standard.

As a very particularly preferred example, oligomeric polyols used are polycaprolactones having an OH number between 540 and 25, an acid number between 0.5 and 1 mg KOH/g and a molar mass between 240 and 10 000 g/mol. Useful polycaprolactones include Capa 3022, Capa 3031, Capa 3041, Capa 3050, Capa 3091, Capa 3201, Capa 3301, Capa 4101, Capa 4801, Capa 6100, Capa 6200, Capa 6250, all from Perstorp in Sweden. It is of course also possible to use mixtures of the polycaprolactones, polyesters, polyethers and polyols.

### Polymerization in Process Step III

The polymerization in process step III. is effected at a temperature T₁ at which the (meth)acrylates are polymerized, but the isocyanate components do not react with the hydroxyl groups. For this purpose, an appropriate initiator is required. Preferably, these initiators are thermally activatable initiators, photoinitiators or free radical-forming redox systems, the initiators preferably being peroxides or redox systems.

Examples of photoinitiators are hydroxy ketones and/or bisacylphosphines. Suitable thermally activatable photoinitiators are, in particular, peroxides, azo initiators or redox systems. Especially peroxides are suitable here. The person skilled in the art selects the initiator on the basis of its half-life and the temperature T₁ used for process step III. In a particular variant, the thermally activatable initiators are combined with an accelerator. Systems of this kind are activatable not just more quickly but also at lower temperatures. Information about suitable initiators and especially combinations of initiators and accelerators can be found, for example, in EP 2 454 331. The combination of the initiators with the accelerators is referred to therein as redox initiator system.

The sum total of the initiators in component A), where the sum total of component A) comprises the sum total of the two individual components mixed to form component A), is at a concentration between 0% and 10% by weight, preferably between 0.2% and 8.0% by weight, more preferably between 0.5% and 6.0% by weight and especially preferably between 1.5% and 5.0% by weight. This concentration is based on the pure initiator. It is entirely possible or even customary that the initiator is added in a solvent or a phlegmatizing agent. These small amounts of added substance are not taken into account hereinafter either in the mass balance of the resin or in the mass balance of the composition. Solvents generally evaporate during further processing. Phlegmatizing agents such as linseed oil or waxes are present only in a very negligible concentration and have a slight plasticizing effect at most in the end product.

Process step III, the curing of the resin component, preferably directly follows process step II. The curing is effected in process step by a thermally initiated polymerization of the monomers in the resin component A). It should be ensured here that the temperature T₁ is below the final curing temperature T₂ required for process step V. Preferably, the temperature T₁ in process step III. is between 20 and 120° C., more preferably below 100° C. T₁ is the temperature of the undermould or of the mould in which initiation or curing is effected in process step III. The temperature can quite possibly rise to a certain degree because of the exothermicity of the polymerization. Preferably, the formulation should be adjusted such that the temperature remains at least 20° C. below the temperature T₂ throughout the polymerization.

The polymer compositions used in accordance with the invention give very good levelling in the case of low viscosity, and hence good impregnatability and, in the cured state, excellent chemical resistance. In the case that aliphatic crosslinkers are used, for example IPDI or H₁₂MDI, the inventive use of the functionalized poly(meth)acrylates additionally achieves good weathering resistance.

The intermediates from process step III. which have been produced in accordance with the invention additionally have very good storage stability under room temperature conditions, generally for several weeks or even months. They can be processed further at any time to give semi-finished composites or composite components. This is the essential difference from the prior art systems, which are reactive and not storage-stable, since they begin to react, for example to give polyurethanes, and hence to crosslink immediately after application.

Thereafter, the storable semi-finished composites can be processed further at a later juncture to give composite components. Use of the inventive semi-finished composites results in very good impregnation of the fibrous carrier, as a result of the fact that the liquid resin components containing the isocyanate component give very good wetting of the fibres of the carrier, with avoidance, through prior homogenization of the polymer composition, of the thermal stress on the polymer composition that can lead to commencement of a second crosslinking reaction; in addition, the process steps of grinding and screening into individual particle size fractions are dispensed with, such that a higher yield of impregnated fibrous carrier can be achieved.

A further great advantage of the semi-finished composites produced in accordance with the invention is that the high temperatures as required at least briefly in the melt impregnation process or in the partial sintering of pulverulent reactive polyurethane compositions are not absolutely necessary in this process according to the invention.

### Particular Aspects of the Process According to the Invention

Process step II, the impregnation, is effected by soaking the fibres, woven fabrics or laid scrims with the reactive composition produced in process step I. Preferably, the impregnation is effected at a temperature of not more than 60° C., more preferably at room temperature.

In process step III, a first shaping operation can already be effected in parallel. For instance, it is possible that, for example in the case of very detailed and simultaneously curved shapes of the end product, the semi-finished product, before being laid into the press or another mould in process step IV, has already been roughly fitted to the complicated shape of this mould, and hence a better product quality, for example in relation to high dimensional accuracy, is achieved. In the case of simpler shapes of the end product, in contrast, it is preferable that the shaping is effected exclusively in process step IV. In addition, especially when the semi-finished products from process step III are stored intermediately, it is possible that preheating and preforming of the semi-finished product are effected in an intermediate step between process steps III and IV. The temperature in this intermediate step should naturally be below the curing temperature in process step V.

For accelerated automation of the process, it is additionally also possible to use a plurality of undermoulds which are run successively into the same mould or the same press. Thus, in parallel to process step IV, it is possible for other undermoulds already to be occupied simultaneously, and optionally for preheating and/or preforming to be effected in this undermould. In a particular embodiment of the invention, the impregnation of process step II and the polymerization of process step III, and also optional preliminary shaping, can additionally already be effected in such an undermould. Alternatively, it is also possible to use a diaphragm.

The semi-finished composites/prepregs produced in accordance with the invention have very high storage stability at room temperature both after process step III. and after process step V. According to the reactive polyurethane composition present, they are stable at least for a few days at room temperature. In general, the semi-finished composites are storage-stable at 40° C. or lower for several weeks, and also at room temperature over several years. The prepregs thus produced are not tacky and therefore have very good handling and further processibility. The reactive or highly reactive polyurethane compositions used in accordance with the invention accordingly have very good adhesion and distribution on the fibrous carrier.

Prior to process step IV, the intermediates from process step III. can be combined to give different shapes and cut to size as required. More particularly, two or more semi-finished composites are consolidated to give a single composite before final crosslinking of the matrix material to give the matrix by cutting the semi-finished composites to size, and optionally sewing or fixing them in some other way. Material which is obtained as offcut material in the cutting-to-size operation can—as described above—be used for further processes.

In process step V, the final curing of the semi-finished composites is effected to give mouldings which have been crosslinked to give a thermoset. This is effected by thermal curing of the hydroxyl groups of the resin component 1 with the isocyanate component. In the context of this invention, this operation of production of the semi-finished composites from the precursors of process step III., according to the curing time, is preferably effected at temperatures between 100 and 200° C., preferably above 160° C., with use of reactive matrix materials (variant I), or in the case of high-reactivity matrix materials provided with appropriate catalysts (variant II) at temperatures above 100° C. More particularly, the curing is conducted at a temperature between 100 and 200° C., more preferably at a temperature between 120 and 200° C. and especially preferably between 140 and 200° C. The time for curing of the polyurethane composition used in accordance with the invention is within 1 to 60 minutes, preferably between 1 and 5 minutes, according to the component complexity.

The reactive polyurethane compositions used in accordance with the invention give very good levelling, and hence good impregnatability and, in the cured state, excellent chemical resistance. When aliphatic crosslinkers (e.g. IPDI or H₁₂MDI) are used, good weathering resistance is additionally achieved.

In addition, the process according to the present invention has the additional advantages that only very low shrinkage and low contraction occur during process steps IV. and V., and that the end product has a particularly good surface quality compared to comparable prior art systems.

However, it is also possible to use specific catalysts to accelerate the reaction in the second curing operation in process step V., for example quaternary ammonium salts, preferably carboxylates or hydroxides, more preferably in combination with epoxides or metal acetylacetonates, preferably in combination with quaternary ammonium halides. These catalyst systems can ensure that the curing temperature for the second curing operation drops down to 100° C., or else that shorter curing times are required at higher temperatures.

### Further Constituents of the Semi-Finished Composites

In addition to the resin component, the carrier material and isocyanate component, the semi-finished composites may include further additives. For example, it is possible to add light stabilizers, for example sterically hindered amines, or other auxiliaries as described, for example, in EP 669 353, in a total amount of 0.05% to 5% by weight. Fillers and pigments, for example titanium dioxide, may be added in an amount of up to 30% by weight of the overall composition. For the production of the reactive polyurethane compositions of the invention, it is additionally possible to add additives such as levelling agents, for example polysilicones, or adhesion promoters, for example based on acrylate.

The invention also provides for the use of the prepregs or semi-finished composites, especially having fibrous carriers composed of glass fibres, carbon fibres or aramid fibres. The invention especially also provides for the use of the semi-finished composites produced in accordance with the invention for production of composites in boat- and shipbuilding, in aerospace technology, in automobile construction, for two-wheeled vehicles, preferably motorcycles and pedal cycles, in the automotive, construction, medical technology and sports sectors, the electrical and electronics industry, and in energy generation installations, for example for rotor blades in wind turbines.

As well as the process according to the invention and the use of the direct process product, specific semi-finished products also form part of the present invention. These semi-finished products are especially notable in that they have a fibrous carrier and a matrix material, the matrix material being composed of a cured resin component and an unreacted isocyanate component in a ratio between 90:10 and 40:60. More particularly, this resin component consists to an extent of at least 30% by weight of a cured (meth)acrylate-based reactive resin, and has an overall OH number between 10 and 600 mg KOH/g. These OH numbers especially describe compositions additionally containing polyol components. In the embodiment in which a pure (meth)acrylate resin is used without additional polyols, the OH number is generally between 10 and 200 mg KOH/g. One example of such a semi-finished product, irrespective of the embodiment based on the polyol, can be taken, for example, from process step III of the process according to the invention.

### EXAMPLES

The following glass fibre scrims or fabrics were used in the examples: Glass filament fabric 296 g/m²- Atlas, Finish FK 144 (Interglas 92626)

### Preparation of the Uretdione-Containing Curing Agent CA:

119.1 g of IPDI uretdione (Evonik Industries) were dissolved in 100 ml of methyl methacrylate, and 27.5 g of propanediol and 3.5 g of trimethylolpropane were added. After adding 0.01 g of dibutyltin dilaurate, the mixture was heated to 80° C. while stirring for 4 h. Thereafter, no free NCO groups were detectable any longer by titrimetric methods. The curing agent CA, based on solids, has an effective NCO latency content of 12.8% by weight.

For Examples 1 and 2, two of these curing agents a) and b) were produced by an identical procedure.

### Reactive Polyurethane Composition

Reactive polyurethane compositions having the formulations which follow were used for production of the prepregs and the composites.

### Example 1

TABLE 1

| | | |
|---|---|---|
| Curing agent CA (60% in | uretdione-containing | 40% by wt. |
| MMA) (effective NCO: 7.7%) | curing agent component a) | |
| 3-Hydroxypropyl | OH-functional monomer | 11% by wt. |
| methacrylate (HPMA) | of the resin component | |
| Methyl methacrylate | monomer of the | 47% by wt. |
| (MMA) | resin component | |
| Dibenzoyl peroxide | initiator | 1% by wt. |
| N,N-bis(2-Hydroxyethyl)- | accelerator | 1% by wt. |
| p-toluidine | | |

To produce the component, 10 plies of glass fibre fabric were stacked one on top of another in a metal mould of size 25×25 cm, which was purged with nitrogen.

The feedstocks from the table were mixed in a premixer and then dissolved. This mixture can be used within about 15 min at RT before it gelates.

The matrix was subsequently applied to the fibres. During the closure operation, the matrix is distributed within the mould and wets the reinforcing fibres. After 20 min, the reaction at RT is complete and it was possible to remove the preform (synonymous here with semi-finished product) from the mould. The preform of Example 1, after the reaction, showed a weight loss based on matrix of about 2% by weight.

The preform was subsequently compressed in a further mould at 180° C. and 50 bar for 1 h, and the matrix material was crosslinked completely in the process. The hard, stiff, chemical-resistant and impact-resistant composite components (sheet material) had a glass transition temperature T_{g} of 118° C.

### Example 2

Example 2 was conducted analogously to Example 1. The only difference was that a resin component which additionally contained non-(meth)acrylic polyols was used. The composition is shown in Table 2.

The procedure for Example 2 was according to Example 1. A weight loss of the preform after the reaction of 1% by weight was measured, rather than 2% by weight in Example 1. The hard, stiff, chemical-resistant and impact-resistant composite components (sheet material) had a glass transition temperature T_{g} of 80° C. and were somewhat more flexible overall than the sheets from Example 1.

TABLE 2

| | | |
|---|---|---|
| Curing agent CA (60% in | uretdione-containing curing | 54% by wt. |
| MMA) (effective NCO: 7.9%) | agent component b) | |
| 3-Hydroxypropyl | OH-functional monomer of | 6% by wt. |
| methacrylate (HPMA) | the resin component | |
| Methyl methacrylate | monomer of the | 22% by wt. |
| (MMA) | resin component | |
| Polyol R3215 | polyol in resin component | 16% by wt. |
| Dibenzoyl peroxide | initiator | 1% by wt. |
| N,N-bis(2-Hydroxyethyl)- | accelerator | 1% by wt. |
| p-toluidine | | |

1. A process for producing a semi-finished composite and further processing thereof to give a moulding, comprising:
I. producing a liquid reactive composition,
II. directly impregnating a fibrous carrier with the composition from I.,
III. polymerizing a monomer constituent in the liquid composition at a temperature T₁, to give a polymerized composition,
IV. shaping the polymerized composition from III. in a press and/or another mould to give the moulding and
V. simultaneously curing the isocyanate component in the composition in the press and/or mold at a temperature T₂,
wherein the composition comprises the following components:
A) a (meth)acrylate-based reactive resin component containing at least one (meth)acrylate monomer and at least one poly(meth)acrylate, wherein at least one constituent of the resin component has a hydroxyl group,
B) at least one blocked di- or polyisocyanate and/or at least one uretdione as isocyanate component,
and wherein the temperature T₂ is at least 20° C. higher than the temperature T₁.

2. The process as claimed in claim 1, wherein the ratio of the resin component to the isocyanate component is between 90:10 and 40:60.

3. The process as claimed in claim 1, wherein the temperature T₁ in III. is between 20 and 120° C.

4. The process as claimed in claim 1, wherein the resin component A) comprises at least
20% by weight to 100% by weight of a monomer, and
0% by weight to 70% by weight of a prepolymer.

5. The process as claimed in claim 4, wherein the resin component A) comprises at least
0% by weight to 10% by weight of a crosslinker,
30% by weight to 90% by weight of a monomer,
0% by weight to 20% by weight of an urethane (meth)acrylate,
0% by weight to 40% by weight of a prepolymer,
0% by weight to 10% by weight of one or more initiators, and
5% by weight to 50% by weight of one or more polyols.

6. The process as claimed in claim 5, wherein the initiator is present and comprises hydroxy ketones and/or bisacylphosphines as photoinitiator and/or a peroxide as thermally activatable initiator and/or a redox accelerator, and wherein the sum total of the initiators is present in the composition in a concentration between 0.2% and 6.0% by weight.

7. The process as claimed in claim 1, wherein the fibrous carrier comprises for the most part glass, carbon, a polymer, a natural fiber, or mineral fiber material, and wherein the fibrous carrier takes the form
of a textile structure in the form of a sheet and made from nonwoven fabric,
of a knitted fabric,
of a non-knitted structure, or
of long fiber or short fiber material.

8. The process as claimed in claim 1, wherein di- or polyisocyanate of component B) is selected from the group consisting of isophorone diisocyanate (IPDI), hexamethylene diisocyanate (HDI), diisocyanatodicyclohexylmethane (H₁₂MDI) 2-methylpentane diisocyanate (MPDI), 2,2,4-trimethylhexamethylene diisocyanate/2,4,4-trimethylhexamethylene diisocyanate (TMDI) and/or norbornane diisocyanate (NBDI), including the isocyanurates, and wherein the di- or polyisocyanate has been blocked with an external blocking agent selected from the group consisting of ethyl acetoacetate, diisopropylamine, methyl ethyl ketoxime, diethyl malonate, ε-caprolactam, 1,2,4-triazole, phenol or a substituted phenol, 3,5-dimethylpyrazole and mixtures thereof.

9. The process as claimed in claim 1, wherein the isocyanate component additionally contains 0.01% of 5.0% by weight of a catalyst.

10. The process as claimed in claim 1, wherein the isocyanate component used is uretdione prepared from isophorone diisocyanate (IPDI), hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI) and/or norbornane diisocyanate (NBDI).

11. The process as claimed in claim 10, wherein the pure isocyanate component is in solid form below 40° C. and in liquid form above 125° C., has a free NCO content of less than 5% by weight and a uretdione content of 3% to 60% by weight, and wherein the isocyanate component additionally contains 0.01% to 5% by weight of at least one catalyst selected from quaternary ammonium salts and/or quaternary phosphonium salts with halogens, hydroxides, alkoxides or organic or inorganic acid anions as counterion.

12. The process as claimed in claim 10, wherein the isocyanate component additionally contains 0.1% to 5% by weight of at least one cocatalyst selected from either at least one epoxide and/or at least one metal acetylacetonate and/or quaternary ammonium acetylacetonate and/or quaternary phosphonium acetylacetonate,
and optionally an auxiliary and/or an additive known from polyurethane chemistry.

13. The process as claimed in claim 1, wherein the resin component and the isocyanate component are present in such a ratio to one another that there is 0.3 to 1.0 uretdione group for every hydroxyl group in the resin component.

14. The process as claimed in claim 5, wherein the resin component contains
10% by weight to 30% by weight of the additional polyol, and wherein the polyol is a low molecular weight polyol having 3 to 6 OH functionalities, a polyester having a molecular weight Mₙ between 200 and 4000 g/mol, an OH number between 25 and 800 mg KOH/g and an acid number less than 2 mg KOH/g, a polyether having an OH number between 25 and 1200 mg KOH/g and a molar mass Mₙ between 100 and 2000 g/mol, or a mixture of at least two of these polyols.

15. The process as claimed in claim 14, wherein the polyester is a polycaprolactone having an OH number between 25 and 540, an acid number between 0.5 and 1 mg KOH/g and a molar mass between 240 and 2500 g/mol.

16. Use of A moulding obtained by the process as claimed in claim 1.

17. A semi-finished product, comprising:
a fibrous carrier and a matrix material,
wherein the matrix material comprises a cured resin component and an unreacted isocyanate component in a ratio between 90:10 and 40:60,
wherein the resin component comprises at least 30% by weight of a cured (meth)acrylate-based reactive resin, and in that the resin component has an OH number between 10 and 600 mg KOH/g.
